(19) United States
(12) Patent Application Publication
(10) Pub. No.: US 2018/0254589 A1
(43) Pub. Date: Sep. 6, 2018

(54) MULTI-FUNCTIONAL CONVERSION AND EXPANSION SOCKET AND SIGNAL INTERACTION SYSTEM USING THE SAME

(71) Applicant: SHENZHEN ANHAORUIHE ELECTRONICS CO., LTD., Shenzhen (CN)

(72) Inventor: XINJIAO CHEN, SHENZHEN (CN)

(21) Appl. No.: 15/584,051

(22) Filed: May 2, 2017

(30) Foreign Application Priority Data
Mar. 2, 2017 (CN) 201720198145.6

(51) Int. Cl. H01R 27/02; H04B 1/38; H04L 12/28; H01R 13/66; H01R 24/60

(52) U.S. Cl. CPC H01R 27/02; H04B 1/38; H04L 12/2818; H01R 2107/00; H01R 24/60; H04L 2012/2841; H04L 2012/2849; H01R 13/6691

(57) ABSTRACT

A multi-functional conversion and expansion socket and a signal interaction system using the same where the socket includes a multiple AC receptacles and a DC jack arranged on a front portion of a housing, multiple plugs are fixed on a rear portion of the housing, a speaker is defined on the housing and formed at two opposite sides of the multiple AC receptacles, the speaker is connected to a wireless signal transceiver via an audio decoder, a trans-modulator is connected to the wireless signal transceiver, the trans-modulator is configured to convert the wireless signal from the wireless signal transceiver into an electric carrier signal via modulation, and to transmit the electric carrier signal to a power grid via a carrier coupler, or to convert the electric carrier signal into a wireless signal via modulation and to transmit the wireless signal via the wireless signal transceiver.

### BACKGROUND OF THE INVENTION

### 1. Field of the Invention

The invention relates to the field of socket produces, and more particularly to a multi-functional conversion and expansion socket, as well as a signal interaction system based on the multi-functional conversion and expansion socket.

### 2. Description of the Prior Art

With development of technologies, people use more and more electronic products in daily lives. To charge or supply power to the electric products significantly enhances people's requirements for the number of power sockets. Therefore, various kinds of expansion sockets appear on the current market. However, these sockets feature a comparatively single function, namely expanding one plug into multiple plugs, and cannot meet requirements of modern society for the products' diversified performance.

### SUMMARY OF THE INVENTION

In view of the above-mentioned problems, it is an objective of the invention to provide a multi-functional conversion and expansion socket, as well as a signal interaction system based on the multi-functional conversion and expansion socket.

In accordance with an exemplary embodiment of the invention, provided is a multi-functional conversion and expansion socket, the socket comprises a housing, multiple AC plugs and a DC jack are arranged on a front panel of the housing, the number of the AC plugs is two or above, multiple plugs are fixed on a rear panel of the housing, and extend towards an rear end thereof, the plugs are respectively connected to a conductive terminal in each of the AC plugs via a conductive part, and a conductive terminal in the DC jack is connected to the plug via an AC-DC conversion circuit;

a speaker is arranged on the housing, the speaker is connected to a wireless signal transceiver via an audio decoder, the audio decoder is configured to extract audio data from a wireless signal from the wireless signal transceiver, and to drive the speaker to operate subsequent to parsing the audio data; and
a trans-modulator is connected to the wireless signal transceiver, the trans-modulator is configured to convert the wireless signal from the wireless signal transceiver into an electric carrier signal via modulation, or to convert the electric carrier signal into a wireless signal via modulation and to transmit the wireless signal via the wireless signal transceiver, a carrier coupler is connected to the trans-modulator, the carrier coupler is connected to the plug, and configured to obtain the electric carrier signal from a power grid via the plug and to transfer the electric carrier signal to the trans-modulator, or to transmit the electric carrier signal transferred by the trans-modulator to the power grid via the plug.

Furthermore, the wireless signal transceiver is a Wi-Fi signal transceiver and/or a Bluetooth signal transceiver.

Furthermore, the DC jack is a USB jack and/or a Type-C jack.

Furthermore, the AC plug on the front panel of the housing and the plug are of the same specification.

In accordance with another exemplary embodiment of the invention, provided is a signal interaction system based on a multi-functional conversion and expansion socket, wherein it comprises a power network, a control terminal device, a controlled terminal device, and the multi-functional conversion and expansion socket of any one of claims 1 to 4, the plug in the multi-functional conversion and expansion socket is connected to the power network, and the control terminal device and the controlled terminal device are connected to the wireless signal transceiver.

In addition to expanding the number of plugs, the invention also provides a speaker and a wireless data interaction function, which makes the invention feature abundant functions, and meet requirements of the modern society for products' diversified performance.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

For the purpose of easy illustration, the invention will be described in details in conjunction to preferred embodiments and accompanying drawings.

FIG. 1 is a front view of a multi-functional conversion and expansion socket of the invention;

FIG. 2 is a top view of a multi-functional conversion and expansion socket of the invention;

FIG. 3 is a schematic view of a multi-functional conversion and expansion socket of the invention; and

FIG. 4 is a schematic view of a signal interaction system of the invention.

### DETAILED DESCRIPTION

Detailed description of the invention will be given below in conjunction with accompanying drawings and specific embodiments. It should be noted that the embodiments are only meant to explain the invention, and not to limit the scope of the invention.

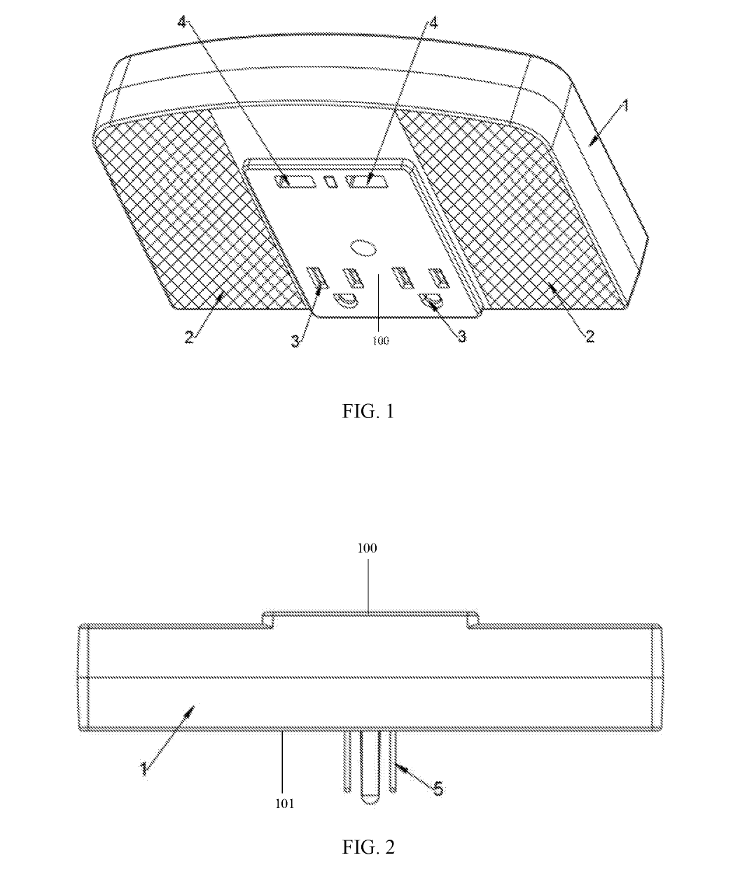

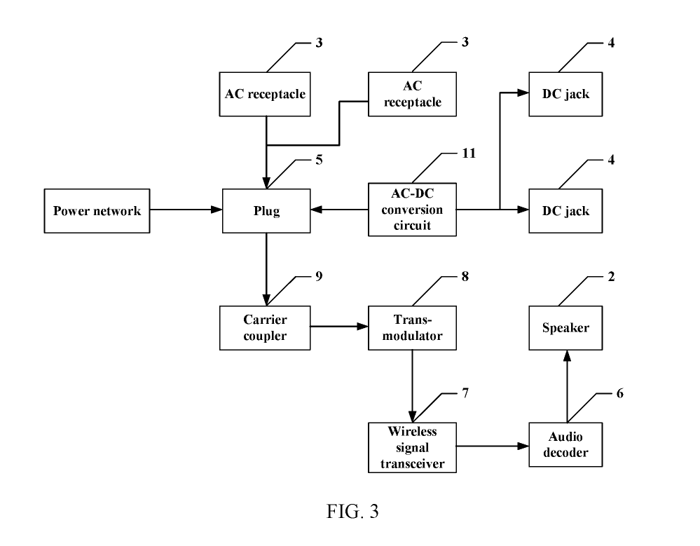

Referring to FIGS. 1 to 3, a multi-functional conversion and expansion socket comprises a housing 1, multiple AC plugs 3 and a DC jack 4 are arranged on a front panel of the housing 1, the number of the AC plugs 3 is two or above, multiple plugs 5 are fixed on a rear panel of the housing 1, and extend towards an rear end thereof, the plugs 5 are respectively connected to a conductive terminal in each of the AC plugs 3 via a conductive part, and a conductive terminal in the DC jack 4 is connected to the plug 5 via an AC-DC conversion circuit 11. The AC-DC conversion circuit 11 is configured to convert AC current in the plug 5 into DC current, and to output the DC current to the DC jack 4 subsequent to reducing voltage thereof.

A speaker 2 is arranged on the housing 1, the speaker 2 is connected to a wireless signal transceiver 7 via an audio decoder 6, the audio decoder 6 is configured to extract audio data from a wireless signal from the wireless signal transceiver 7, and to drive the speaker 2 to operate subsequent to parsing the audio data.

A trans-modulator 8 is connected to the wireless signal transceiver 7, the trans-modulator 8 is configured to convert the wireless signal from the wireless signal transceiver 7 into an electric carrier signal via modulation, or to convert the electric carrier signal into a wireless signal via modulation and to transmit the wireless signal via the wireless signal transceiver 7. A carrier coupler 9 is connected to the trans-modulator 8, the carrier coupler 9 is connected to the plug 5, and configured to obtain the electric carrier signal from a power grid via the plug 5 and to transfer the electric carrier signal to the trans-modulator 8, or to transmit the electric carrier signal transferred by the trans-modulator 8 to the power grid via the plug 5.

Furthermore, the wireless signal transceiver 7 is a Wi-Fi signal transceiver and/or a Bluetooth signal transceiver.

Furthermore, the DC jack 4 is a USB jack and/or a Type-C jack.

Furthermore, the AC plug 3 on the front panel of the housing 1 and the plug 5 are of the same specification.

The multi-functional conversion and expansion socket of the invention having the AC plug 3 and the DC jack 4 can expand the AC plug 3, charge digital devices via the DC jack 4, input the audio data transmitted from an external control terminal device via the wireless signal, control the speaker 2 to play the audio data, and transmit a control signal transferred by the external control terminal device to an external power grid in the form of an electric carrier via the wireless signal; meanwhile, the socket can also transmit the electric carrier signal obtained from the external power grid to an external controlled terminal device via the wireless signal transceiver 7, and thus facilitating signal interaction.

Referring to FIG. 4, a signal interaction system based on a multi-functional conversion and expansion socket comprises a power network, a control terminal device 20, a controlled terminal device 30, and the above-mentioned multi-functional conversion and expansion socket 10. The plug 5 in the multi-functional conversion and expansion socket 10 is connected to a power network, and the control terminal device 20 and the controlled terminal device 30 are connected to the wireless signal transceiver 7.

While preferred embodiments of the invention have been described above, the invention is not limited to disclosure in the embodiments and the accompanying drawings. Any changes or modifications without departing from the spirit of the invention fall within the scope of the invention.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A multi-functional conversion and expansion socket, wherein
said socket comprises a housing, multiple AC receptacles and a DC jack are arranged on a front portion of said housing, the number of said AC receptacles is two or above, multiple plugs are fixed on a rear portion of said housing, and extend towards an rear end thereof, said plugs are respectively connected to a conductive terminal in each of said AC receptacles via a conductive part, and a conductive terminal in said DC jack is connected to said plug via an AC-DC conversion circuit;
a speaker defined on said housing and formed at two opposite sides of the multiple AC receptacles, said speaker is connected to a wireless signal transceiver via an audio decoder, said audio decoder is configured to extract audio data from a wireless signal from said wireless signal transceiver, and to drive said speaker to operate subsequent to parsing said audio data; and
a trans-modulator is connected to said wireless signal transceiver, said trans-modulator is configured to convert said wireless signal from said wireless signal transceiver into an electric carrier signal via modulation, or to convert said electric carrier signal into a wireless signal via modulation and to transmit said wireless signal via said wireless signal transceiver, a carrier coupler is connected to said trans-modulator, said carrier coupler is connected to said plug, and configured to obtain said electric carrier signal from a power grid via said plug and to transfer said electric carrier signal to said trans-modulator, or to transmit said electric carrier signal transferred by said trans-modulator to said power grid via said plug.

2. A signal interaction system based on a multi-functional conversion and expansion socket, wherein it comprises a power network, a control terminal device, a controlled terminal device, and the multi-functional conversion and expansion socket of claim 1, said plug in said multi-functional conversion and expansion socket is connected to said power network, and said control terminal device and said controlled terminal device are connected to said wireless signal transceiver.

3. The multi-functional conversion and expansion socket of claim 1, wherein said wireless signal transceiver is a Wi-Fi signal transceiver and/or a Bluetooth signal transceiver.

4. A signal interaction system based on a multi-functional conversion and expansion socket, wherein it comprises a power network, a control terminal device, a controlled terminal device, and the multi-functional conversion and expansion socket of claim 3, said plug in said multi-functional conversion and expansion socket is connected to said power network, and said control terminal device and said controlled terminal device are connected to said wireless signal transceiver.

5. The multi-functional conversion and expansion socket of claim 3, wherein said DC jack is a USB jack and/or a Type-C jack.

6. A signal interaction system based on a multi-functional conversion and expansion socket, wherein it comprises a power network, a control terminal device, a controlled terminal device, and the multi-functional conversion and expansion socket of claim 5, said plug in said multi-functional conversion and expansion socket is connected to said power network, and said control terminal device and said controlled terminal device are connected to said wireless signal transceiver.

7. The multi-functional conversion and expansion socket of claim 5, wherein the specification of said AC receptacle is matched with that of said plug.

8. A signal interaction system based on a multi-functional conversion and expansion socket, wherein it comprises a power network, a control terminal device, a controlled terminal device, and the multi-functional conversion and expansion socket of claim 7, said plug in said multi-functional conversion and expansion socket is connected to said power network, and said control terminal device and said controlled terminal device are connected to said wireless signal transceiver.
